(19) United States
(12) Patent Application Publication
(10) Pub. No.: US 2006/0150828 A1
(43) Pub. Date: Jul. 13, 2006

(54) Dried infant cereal compositions

(75) Inventors: Debra Quackenbush, Palatine Bridge, NY (US); Robert Harvey, St. Johnsville, NY (US); Richard Theuer, Raleigh, NC (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Beech-Nut Nutrition Corporation, St. Louis, MO (US)

(21) Appl. No.: 11/329,902

(22) Filed: Jan. 11, 2006

Related U.S. Application Data
(60) Provisional application No. 60/643,039, filed on Jan. 11, 2005.

(51) Int. Cl. A01J 11/04

(52) U.S. Cl. 99/467

(57) ABSTRACT

A dried infant cereal composition is disclosed comprising one or more cereal grains, an iron compound slightly soluble in water but readily soluble in dilute acids in an amount sufficient to provide not less than about 30 mg of iron per 100 grams and not more than about 75 mg of iron per 100 grams, one or more vitamins, and no ingredients requiring labeling as a major food allergen. The iron compound slightly soluble in water but readily soluble in dilute acids is selected from the group consisting of ferrous fumarate, ferrous succinate, or ferrous saccharate. The one or more vitamins can include without limitation ascorbic acid. The composition is free of ingredients requiring labeling as a major food allergen, said major food allergens being milk, eggs, fish, Crustacean shellfish, tree nuts, peanuts, wheat, and soybeans.

### CROSS-REFERENCE TO RELATED APPLICATIONS

This application claims the benefit of priority of U.S. provisional application 60/643,039 filed Jan. 11, 2005, which application is incorporated herein by reference in its entirety.

### FIELD

This application relates generally to dried infant cereal compositions which are used to prepare a semi-solid pap for feeding babies, and, in particular to dried infant cereal compositions containing an iron source that is slightly soluble in water, but readily soluble in dilute acids. The pap can be prepared by mixing the dried cereal composition with an acceptable liquid such as breast milk, infant formula, cows' milk, water, or fruit juice.

### BACKGROUND

Paps prepared from dried infant cereal compositions are the first semi-solid foods fed to most young infants. Dried infant cereals are recognized as vehicles for iron fortification of the infant diet. The dried infant cereals should be easily digested and well-tolerated by infants.

### SUMMARY

Accordingly, the present inventors have succeeded in devising compositions and methods for improved dried infant cereal compositions comprising one or more cereal grains and one or more iron compounds slightly soluble in water in an acceptable infant-food formulation suitable for feeding to an infant. The iron compounds can also be readily soluble in dilute acids. The composition can contain an amount of the one or more iron compounds sufficient to provide not less than 30 milligrams of iron and not more than about 75 milligrams per 100 grams on a dry weight basis in the dried infant cereal. The composition can also contain, one or more vitamins, and no ingredients requiring labeling as major allergens such as, for example any ingredient that contains protein derived from a food from one or more of the eight major foods or food groups (milk, eggs, fish, Crustacean shellfish, tree nuts, peanuts, wheat, and soybeans) that account for 90 percent of food allergies.

Thus, in various embodiments, the present invention can involve a dried infant cereal composition comprising one or more cereal grains and one or more compounds that are slightly soluble in water. The iron compounds, in various embodiments, can also be readily soluble in dilute acids. The iron compounds can be present in a total amount sufficient to provide not less than about 30 mg, and not more than about 75 mg of iron per 100 grams of composition on a dry matter basis. The composition can be in an acceptable infant-food formulation suitable for feeding to an infant. The composition can also contains one or more vitamins and no further ingredients requiring labeling as a major allergen.

The present invention, in various embodiments, can also include methods of providing dietary iron to an infant. The methods can comprise feeding to the infant a dried infant cereal composition comprising one or more cereal grains and one or more compounds that are slightly soluble in water. The iron compounds, in various embodiments, can be readily soluble in dilute acids. The iron compounds can be present in the composition in a total amount sufficient to provide not less than about 30 mg of iron per 100 grams of composition on a dry matter basis and not more than about 75 mg of iron per 100 grams of composition on a dry matter basis. The composition can be in an acceptable infant-food formulation suitable for feeding to an infant. The composition can also contains one or more vitamins and no further ingredients requiring labeling as a major allergen.

In various embodiments of the compositions and methods of the present invention, the compositions can contain one or more substances such as vitamins including vitamins such as ascorbic acid (vitamin C), B vitamins such as thiamine (B-1), riboflavin (B-2), niacin, folic acid, pyridoxine (B-6), cyanocobalamin (B-12), pantothenic acid, biotin, fat-soluble vitamins such as vitamin E, vitamin K, vitamin D, and vitamin A; vitamin-like substances including choline, inositol, carnitine, and the like; and minerals other than iron, including zinc, calcium, phosphorus, magnesium, copper, iodine, and manganese. In various embodiments, the compositions and methods can contain ascorbic acid in an amount sufficient to provide not less than about 5 mg of Vitamin C activity per 100 grams of the composition on a dry matter basis or not less than 45 mg of Vitamin C activity per 100 grams of the composition on a dry matter basis.

In various embodiments, the one or more iron compounds slightly soluble in water but readily soluble in dilute acids can be an iron salt of an organic acid selected from the group consisting of ferrous fumarate, ferrous succinate, ferric saccharate and combinations thereof.

In various embodiments, the one or more cereal grains can be one selected from the group consisting of rice, oats, corn, barley, white potato, arrowroot, buckwheat and combinations thereof.

In various embodiments, the present invention can include methods for producing a dried infant cereal composition. The methods can comprise (a) preparing a slurry of water and one or more one or more cereal grains; (b) adding ferrous fumarate to the slurry in an amount sufficient to provide not less than about 30 mg of iron per 100 grams and not more than about 75 mg of iron per 100 grams in the composition and drum-drying the slurry. The methods can further comprise, in various embodiments, adding ascorbic acid to the slurry prior to drum drying, in an amount sufficient to provide not less than about 45 mg of Vitamin C in the composition on a dry matter basis.

### DETAILED DESCRIPTION

The present invention, in various embodiments, can involve methods and compositions for dried infant cereal compositions comprising one or more cereal grains and one or more iron compounds. The one or more iron compounds can be present in amounts sufficient to provide a total of not less than about 10 milligrams, not less than about 15 mg, not less than about 20 mg, not less than about 25 mg, not less than about 30 mg, not less than about 35 mg, not less than about 40 mg, not less than about 45 mg, not less than about 50 mg, not less than about 55 mg, or not less than about 60 mg of iron on a dry matter basis and not more than about 100 mg, not more than about 95 mg, not more than about 90 mg, not more than about 85 mg, not more than about 80 mg, not more than about 75 mg, not more than about 70 mg, or not more than about 65 mg, of the composition on a dry matter basis; and, in particular, not less than about 30 milligrams of iron and not more than about 75 milligrams of iron per 100 grams in the dried cereal. In various embodiments, the compositions can contain one or more vitamins, and no ingredients requiring labeling as major allergens.

Iron compounds commonly used for fortification of food can be divided into four groups: (1) those that are freely water-soluble; (2) those that are slightly water-soluble but soluble in dilute acids such as gastric juice; (3) those that are water-insoluble but slightly soluble in dilute acids; and (4) protected iron compounds. (Hurrell Nutrition Reviews 55:210-222, 1997).

Iron compounds may cause unacceptable changes in color and flavor when added to foods. Many iron compounds are colored and cannot be used to fortify light-colored foods. In addition, the more soluble iron compounds often react with substances in foods, causing discoloration. Infant cereals have been found to turn gray or green on addition of ferrous sulfate and dark blue if bananas are present.

The catalytic effect of iron on fat oxidation in cereals during storage is a major problem. Water-soluble compounds, such as ferrous sulfate, promote fat oxidation and reduce product shelf life. A convenient method to measure the potential of iron fortification compounds to promote fat oxidation in cereals is to measure pentane formation in the headspace of sealed cans containing the iron-fortified product. Pentane is the major hydrocarbon formed by the oxidative degradation of linoleic acid, and its formation correlates with the production of off-flavors. During storage at 37° C. of a precooked whole wheat flour containing various iron salts, ferrous sulfate and ferrous gluconate rapidly generated pentane and were judged unacceptable by a taste panel after 4 to 6 weeks of storage. Ferric pyrophosphate and reduced elemental iron generated far less pentane and were still organoleptically acceptable after 7 weeks of storage.

Freely water-soluble iron compounds are the most bioavailable iron compounds, but also the most likely to promote unacceptable color and flavor changes. Ferrous sulfate is the least expensive iron compound and is widely used to fortify infant formulas and pasta and cereal flour that are stored for only short periods. Other freely-soluble iron compounds include without limitation ferrous gluconate, ferrous lactate, and ferric ammonium citrate. Iron compounds that are freely water soluble are soluble in water in an amount of at least about 2 grams/100 ml, at least about 5 grams/100 ml, at least about 10 grams/100 ml, or at least about 20 grams/100 ml. In particular, such iron compounds are soluble in water in an amount of at least about 2 grams/100 ml.

Several iron compounds are slightly soluble in water. Such compounds can be readily soluble in dilute acids. These compounds include without limitation ferrous fumarate, ferrous succinate, and ferric saccharate. Their advantage is that they cause far fewer organoleptic problems than freely water-soluble compounds and still readily enter the common iron pool during digestion. Iron compounds that are slightly soluble in water are soluble in water in an amount of not more than about 2 grams/100 ml, not more than about 1 gram/100 ml, or not more than about 0.5 grams/100 ml. In particular, such compounds are soluble in water in an amount of not more than about 1 gram/100 ml and at least about 0.01 grams/100 ml. By readily soluble in dilute acids it is meant that the iron compound is soluble in dilute acid such as, for example 0.1 N HCl in an amount of at least about 0.4 grams/100 ml, at least about 0.5 grams/100ml, at least about 1 gram/100 ml, at least about 2 grams/100 ml, at least about 5 grams/100 ml or at least about 10 grams/100 ml.

Iron compounds that are water-insoluble and slightly soluble in dilute acids include without limitation ferric pyrophosphate, ferric orthophosphate, ferric ammonium orthophosphate, and the elemental iron powders made by carbonyl, electrolytic, or reduction techniques. Iron compounds that are water-insoluble and slightly soluble in dilute acids are the most often-used compounds in food fortification. Their main advantage is that they cause no organoleptic problems. Their disadvantage is that they have a variable absorption because they do not readily dissolve in gastric juice.

Protected iron compounds include ferrous sulfate and ferrous fumarate available commercially in encapsulated form. These forms are expensive. Commonly, the coatings are partially hydrogenated oils, such as soybean and cottonseed, or ethyl cellulose. The coating has little influence on bioavailability and can prevent fat oxidation changes during storage of cereals. Most coatings are heat labile, however, and at temperatures above 50 to 70° C. often do not prevent unwanted color reactions. Zinc stearate is the only coating proposed that has a high melting point (122° C., and its bioavailability was reported to be just 70% that of ferrous sulfate.

The term “cereal grain” as used herein includes without limitation the edible products, such as flours, grits, groats, and the like, of edible seeds of grasses, such as rice, oats, corn, barley, rye, wheat, and related plant species; the products, such as flours, grits, and the like, of starchy roots, tubers, and rhizomes such as arrowroot, white potatoes, sweet potatoes, and products, such as flours, grits, and the like, of edible plants used in the same manner that cereals are commonly used in the diet, examples of such edible plants being buckwheat, quinoa, and millet.

The term “vitamins” includes, without limitation, whether water-soluble or fat-soluble, ascorbic acid, thiamine, niacin, retinol palmitate, phytonadione, riboflavin, pyridoxine hydrochloride, cyanocobalamin, sodium ascorbate, ascorbyl palmitate, cholecalciferol, nicotinic acid amide, calcium pantothenate, folic acid, biotin, inositol, and choline.

The term “Vitamin C” as used herein refers to ascorbic acid [The Merck Index, 12^{th} Ed., (p. 139) 1996] and dehydroascorbic acid [The Merck Index, 12^{th} Ed., (p. 485) 1996], and also alkali and alkaline salts and derivatives of these acids. Examples of said alkali and alkaline salts include, without limitation, sodium ascorbate [The Merck Index, 12^{th} Ed., (p. 1471) 1996] and calcium ascorbate [The Merck Index, 12^{th} Ed., (p. 270) 1996]. An example of said derivatives is ascorbyl palmitate.

Eight major foods or food groups—milk, eggs, fish, Crustacean shellfish, tree nuts, peanuts, wheat, and soybeans—account for 90 percent of food allergies. Consequently, the term ‘major food allergen’ is defined to mean any of the following milk, egg, fish (e.g., bass, flounder, or cod), Crustacean shellfish (e.g., crab, lobster, or shrimp), tree nuts (e.g., almonds, pecans, or walnuts), wheat, peanuts, and soybeans. A food ingredient that contains protein derived from one or more major food allergens must be clearly labeled to protect sensitive consumers. A highly refined oil derived from a major food allergen contains no protein, so an exception is granted for any highly refined oil and any ingredient derived from such highly refined oil. In contrast, an oily ingredient originating from one or more major food allergens, said ingredient not being highly refined, is customarily labeled as containing a major food allergen. For example, the surface active soy ingredient, soy lecithin, is so labeled on many food labels.

The compositions of the present invention can be in an acceptable infant-food formulation or preparation suitable for feeding to an infant. An acceptable infant-food formulation is one suitable for feeding to a infant and included within the meaning of the terms acceptable baby-food formulation is any regulatory agency requirements for foods intended for consumption by infants. For example, lactic acid and malic acid have been reviewed by the Food and Drug Administration and determined not to be generally recognized as safe for use in infant foods. (see 21 C.F.R. .sctn.184.1061, .sctn.184.1069). Thus, these acids would not be incorporated into an acceptable infant-food formulation. On the other hand, the use of citric acid and phosphoric acid have been determined to be generally recognized as safe (see 21 C.F.R.§184.1033, § 182.1073). Therefore, these acids can be incorporated into an acceptable infant-food formulation.

In addition, an acceptable infant-food formulation is one whose overall combination of organoleptic characteristics, i.e., taste, mouthfeel/texture, odor and color/appearance, is sufficiently satisfactory that the infant will consume the formulation and the caregiver will serve the formulation to the infant. For example, infants are known to display an aversion to bitter tastes at a very early age and to strong flavors such as can be present in some vegetables (Trahms, in Nutrition in Infancy and Childhood, Pipes and Trahms, Eds, Mosby, St. Louis, 1993, pp. 181-194; Kajiura et al, Developmental Psychobiol 25:375-386; Rosenstein et al., Child Develop 59:1555-1568, 1988; Lowenberg, in Nutrition in Infancy and Childhood, Pipes and Trahms, Eds, Mosby, St. Louis, 1993, pp. 165-180; Brooks, supra; Lawless, supra; Ashbrook et al, J Nutrition Ed 17:5, 6, 46, 1985; Beal Pediatrics 20:448-456, 1957). Therefore, an acceptable formulation of a infant-food composition does not have a strong bitter taste or a strong flavor.

An acceptable infant-food formulation will also have a texture that is acceptable to the infant. For example, foods that are too dry or gritty are usually unacceptable to infants. In general, acceptable baby-food formulations will be smooth in texture. In addition, younger infants typically prefer food that is soft and homogenous. For older infants, however, a nonhomogenous texture may be desired. Because of such preferences, baby foods are typically produced in different forms, depending on the age of the intended consumer. For example, BEECH-NUT Stage 1 products are intended to be consumed by babies from about three months of age. BEECH-NUT Stage 2 products, which are strained and will pass through a 0.050″ orifice, are intended to be consumed by infants from about six months of age. Infants of about nine months of age and older are the intended consumers of BEECH-NUT Stage 3 Junior products, which have chunky components that will pass through a ⅜ inch screen.

Moreover, the color and appearance of the formulation are such that the infant or the adult caregiver will not reject the formulation. Acceptable colors tend to be light rather than dark. Preferably, acceptable color is achieved using the whole food concept in which food components are added which produce the desired color for the overall mixture. The appearance of the formulation should also be smooth and homogenous.

For infant cereals, acceptable preparations can require pre-cooking and pre-digesting with natural enzymes to make them easier for the infant to digest. This processing also keeps the infant cereal from getting too thick when it is mixed with milk or formula.

Enzyme-treated flours of cereals are flours prepared with enzymes such that the starch has been at least partially transformed into dextrin, maltodextrin, maltose and glucose. When reconstituted according to the label directions for use, dry cereal is of a soft, smooth texture, free of lumps and chewable particles, and is suitable for spoon feeding of infants and children. (CODEX STAN 74-1981 §§ 2.1.3 and 3.4.1). Thus, the organoleptic acceptability of cereal compositions can improved by enzyme-treatment of the cereal flours.

The following examples are illustrative of the present invention, but it is understood that the invention is not limited thereto.

### EXAMPLE 1

This example illustrates the preparation of a dried infant rice cereal free of wheat, soy, milk, and other major food allergens, made with the following ingredients.

| | Percentage | | |
|---|---|---|---|
| Weighed Ingredient | of batch | Weight/batch | |
| Long-grain Rice Flour | 94.56% | 200.0 | lb. |
| Tricalcium Phosphate | 3.78% | 8.0 | lb. (3629 g) |
| High Oleic Sunflower Oil | 0.86% | 1.83 | lb. (830 g) |
| Ascorbic Acid | 0.25% | 0.54 | lb. (245 g) |
| Rice Bran Extract | 0.25% | 0.54 | lb. (245 g) |
| Ferrous Fumarate | 0.18% | 0.387 | lb. (177 g) |
| B-Vitamin & Mineral Premix | 0.08% | 0.172 | lb. (78 g) |
| alpha-Tocopherol Acetate | 0.02% | 0.043 | lb. (20 g) |
| Mixed Tocopherols | 0.02% | 0.043 | lb. (20 g) |
| TOTAL | 100.00% | 211.555 | lb. (95.96 kg) |

Preparation of Cold Cereal Slurry, Softened water, 32 gallons (121 kg), was metered into a mixing tank. The alpha-tocopherol acetate and mixed tocopherols were mixed with the high oleic sunflower oil. The sunflower oil containing the tocopherols, rice bran extract (Nu-RICE, RIBUS, Inc., St. Louis, Mo. 63105), tricalcium phosphate, ascorbic acid, vitamin premix, and ferrous fumarate were added to the mixing tank, followed by the rice flour. The slurry was mixed until all ingredients were in suspension. The portion of the batch that was not to be treated with amylolytic enzyme was pumped to a cold slurry tank.

Preparation of Treated Slurry

Amylolytic enzyme (BAN 800 MG, Novozymes North America, Franklinton, N.C. 27525) was added to a portion of the cereal slurry at a rate of approximately 0.055 lb. of enzyme per 100 lb. of rice flour. The enzyme was dissolved in about one quart of softened tap water at a temperature no greater than 110° F. Cold cereal slurry was pumped to an enzyme mixing tank. The enzyme solution was added and mixed with the cereal slurry for no less than 5 minutes. The treated slurry was then heated to 180° F. to 200° F. and transferred to a converted slurry tank.

Production of Dried Cereal

The treated slurry and the untreated slurry were combined at a rate of approximately 50% treated to 50% untreated to achieve a required final consistency of 15 to 45 FMC units with a target consistency of 25 to 35 FMC units. The combined cereal slurry was then heated to 275° F. to 285° F. and fed to a single drum dryer. The rotation speed, applicator rolls clearance, and steam pressure were adjusted to maintain the desired dry cereal characteristics.

The dried cereal was then conveyed pneumatically to clean, dry tote bins for room-temperature storage prior to the packaging operation, as is well-known to those skilled in the art. The cereal was later filled into cardboard cartons and labeled appropriately.

The cereal was analyzed to ensure compliance with the following standards.

| | |
|---|---|
| Moisture | 4.0 to 6.5% |
| Protein (N × 6.25) | Min. 5.0 g/100 g |
| Carbohydrates | Max. 84.5 g/100 g |
| Fat (Acid Hydrolysis) | Max. 2.5 g/100 g |
| Calcium | Min. 1000 mg/100 g |
| Iron | Min. 45 mg/100 g |
| Zinc | Min. 8.62 mg/100 g |
| Thiamine (Vit. B1) | Min. 0.83 mg/100 g |
| Riboflavin(Vit. B2) | Min. 1 mg/100 g |
| Niacin | Min. 13.27 mg/100 g |
| Vitamin E | Min. 8.33 IU/100 g |
| Vitamin C (in-process) | Min. 90 mg/100 g |
| Vitamin C | Min. 58.33 mg/100 g |
| Pantothenic Acid | Min. 4.98 mg/100 g |
| Vitamin B6 | Min. 0.66 mg/100 g |
| Vitamin B12 | Min. 0.0033 mg/100 g |
| Folic Acid | Min. 0.17 mg/100 g |

Samples of the cereal were collected about every five minutes and analyzed for iron. The range of iron contents found in the fifteen samples analyzed was 49.71 to 56.73 mg/100 g. The mean±standard deviation was 52.23 ±1.93 mg/100 g. The label claim for iron was equal to 45 mg/100 g.

The ingredient declaration of the packaged product was as follows: Ingredients: Rice Flour, Contains less than 1% of the following: Sunflower Oil and Rice Bran Extract.
Vitamins and Minerals: Tricalcium Phosphate, Ascorbic Acid (Vitamin C), Ferrous Fumarate (source of iron), Zinc Sulfate, D-alpha-Tocopherol Acetate (Vitamin E), Niacinamide, Mixed Tocopherols, Calcium Pantothenate, Thiamine Mononitrate (Vitamin B1), Riboflavin (Vitamin B2), Pyridoxine Hydrochloride (Vitamin B6), Vitamin B12 and Folic Acid.

### EXAMPLE 2

This example illustrates the recipe of a dried infant rice cereal free of wheat, soy, milk, and other major food allergens and containing ferrous fumarate and one or more vitamins, that can be made with monoglyceride in place of rice bran extract as a drum drying aid.

| | Percentage | | |
|---|---|---|---|
| Weighed Ingredient | of batch | Weight/batch | |
| Long-grain Rice Flour | 94.56% | 200.0 | lb. |
| Tricalcium Phosphate | 3.67% | 7.76 | lb. (3518 g) |
| High Oleic Sunflower Oil | 0.83% | 1.76 | lb. (800 g) |
| Distilled Monoglyceride | 0.40% | 0.85 | lb. (386 g) |
| Ascorbic Acid | 0.25% | 0.54 | lb. (245 g) |
| Ferrous Fumarate | 0.18% | 0.387 | lb. (177 g) |
| B-Vitamin & Mineral Premix | 0.08% | 0.172 | lb. (78 g) |
| alpha-Tocopherol Acetate | 0.02% | 0.043 | lb. (20 g) |
| Mixed Tocopherols | 0.02% | 0.043 | lb. (20 g) |
| TOTAL | 100.00% | 211.555 | lb. (95.96 kg) |

### EXAMPLE 3

This example illustrates the recipe of a dried infant oatmeal cereal free of wheat, soy, milk, and other major food allergens, that can be made with ferrous fumarate and one or more vitamins.

| | Percentage | | |
|---|---|---|---|
| Weighed Ingredient | of batch | Weight/batch | |
| Oat Flour | 96.26% | 600.0 | lb. |
| Tricalcium Phosphate | 3.05% | 19.0 | lb. |
| Ascorbic Acid | 0.39% | 2.425 | lb. (1100 g) |
| Ferrous Fumarate | 0.18% | 1.158 | lb. (525 g) |
| B-Vitamin & Mineral Premix | 0.08% | 0.515 | lb. (234 g) |
| alpha-Tocopherol Acetate | 0.02% | 0.129 | lb. (59 g) |
| Mixed Tocopherols | 0.02% | 0.129 | lb. (59 g) |
| TOTAL | 100.00% | 623.36 | lb. |

All references cited in this specification are hereby incorporated by reference. Any discussion of references cited herein is intended merely to summarize the assertions made by their authors and no admission is made that any reference or portion thereof constitutes relevant prior art. Applicants reserve the right to challenge the accuracy and pertinence of the cited references.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A dried infant cereal composition comprising one or more cereal grains and one or more iron compounds slightly soluble in water in a total amount sufficient to provide not less than about 30 mg of iron per 100 grams and not more than about 75 mg of iron per 100 grams of composition on a dry matter basis in an acceptable infant-food formulation suitable for feeding to an infant.

2. A composition of claim 1, wherein the one or more iron compounds are readily soluble in dilute acids.

3. A composition of claim 1, wherein the one or more iron compounds are iron salts of one or more organic acids.

4. A composition of claim 1, wherein the composition further contains one or more vitamins.

5. A composition of claim 1, wherein the composition contains no ingredients requiring labeling as a major allergen.

6. A composition of claim 1, wherein the one or more vitamins comprise ascorbic acid in an amount sufficient to provide not less than about 5 mg of Vitamin C activity per 100 grams of the composition.

7. A composition of claim 6, wherein the amount of ascorbic acid is sufficient to provide not less than 45 mg of Vitamin C activity per 100 grams of the composition.

8. A composition of claim 1, wherein the iron compound slightly soluble in water but readily soluble in dilute acids is selected from the group consisting of ferrous fumarate, ferrous succinate, and ferric saccharate.

9. A composition of claim 8, wherein the iron compound is ferrous fumarate.

10. A composition of claim 1, wherein one of the one or more cereal grains is selected from the group consisting of rice, oats, corn, barley, white potato, arrowroot, and buckwheat.

11. A composition of claim 9, wherein one of the one or more cereal grains is rice.

12. A composition of claim 10, wherein one of the one or more cereal grains is oats.

13. A composition of claim 1, wherein the amount of iron compound slightly soluble in water but readily soluble in dilute acids provides not less than about 45 mg of iron per 100 grams of the composition.

14. A composition of claim 1, wherein the amount of iron compound slightly soluble in water but readily soluble in dilute acids provides not more than about 60 mg of iron per 100 grams of the composition.

15. A composition of claim 1, wherein one of the one or more cereal grains is rice, the iron compound slightly soluble in water but readily soluble in dilute acids is ferrous fumarate, the amount of iron compound slightly soluble in water but readily soluble in dilute acids provides not less than about 45 mg of iron per 100 grams and not more than about 60 mg of iron per 100 grams in the composition, and the amount of ascorbic acid is sufficient to provide not less than 45 mg of Vitamin C activity per 100 grams of the composition.

16. A method of providing dietary iron to an infant, the method comprising feeding to the infant a dried infant cereal composition comprising one or more cereal grains and one or more iron compounds slightly soluble in water, said iron compounds being present in the composition in a total amount sufficient to provide not less than about 30 mg of iron per 100 grams and not more than about 75 mg of iron per 100 grams of composition on a dry matter basis in an acceptable infant-food formulation suitable for feeding to an infant.

17. A method of claim 16, wherein the one or more iron compounds are readily soluble in dilute acids.

18. A method of claim 16, wherein the one or more iron compounds are iron salts of one or more organic acids.

19. A method of claim 16, wherein the composition further contains one or more vitamins.

20. A method of claim 16, wherein the composition contains no ingredients requiring labeling as a major allergen.

21. A method of claim 16, wherein the one or more vitamins comprise ascorbic acid in an amount sufficient to provide not less than about 5 mg of Vitamin C activity per 100 grams of the composition.

22. A method of claim 21, wherein the amount of ascorbic acid is sufficient to provide not less than 45 mg of Vitamin C activity per 100 grams of the composition.

23. A method of claim 16, wherein the iron compound slightly soluble in water but readily soluble in dilute acids is selected from the group consisting of ferrous fumarate, ferrous succinate, and ferric saccharate.

24. A method of claim 23, wherein the iron compound is ferrous fumarate.

25. A method of claim 16, wherein one of the one or more cereal grains is selected from the group consisting of rice, oats, corn, barley, white potato, arrowroot, and buckwheat.

26. A method of claim 25, wherein one of the one or more cereal grains is rice.

27. A method of claim 25, wherein one of the one or more cereal grains is oats.

28. A method of claim 16, wherein the amount of iron compound slightly soluble in water but readily soluble in dilute acids provides not less than about 45 mg of iron per 100 grams of the composition.

29. A method of claim 16, wherein the amount of iron compound slightly soluble in water but readily soluble in dilute acids provides not more than about 60 mg of iron per 100 grams of the composition.

30. A method of claim 16, wherein one of the one or more cereal grains is rice, the iron compound slightly soluble in water but readily soluble in dilute acids is ferrous fumarate, the amount of iron compound slightly soluble in water but readily soluble in dilute acids provides not less than about 45 mg of iron per 100 grams and not more than about 60 mg of iron per 100 grams in the composition, and the amount of ascorbic acid is sufficient to provide not less than 45 mg of Vitamin C activity per 100 grams of the composition.

31. A method for producing a dried infant cereal composition comprising:
(a) preparing a slurry of water and one or more one or more cereal grains;
(b) adding ferrous fumarate to the slurry in an amount sufficient to provide not less than about 30 mg of iron per 100 grams and not more than about 75 mg of iron per 100 grams in the composition on a dry matter basis;
(c) adding ascorbic acid to the slurry in an amount sufficient to provide not less than about 45 mg of Vitamin C in the composition on a dry mater basis; and
(d) then drum-drying the slurry.
